(19) United States
(12) Patent Application Publication
(10) Pub. No.: US 2006/0176910 A1
(43) Pub. Date: Aug. 10, 2006

(54) Method and system for producing and transmitting multi-media

(75) Inventors: Hsu-Hung Huang, Uen-Lin Hsien (TW); Chen-Yu Yeh, Tainan City (TW)

Correspondence Address: BIRCH STEWART KOLASCH & BIRCH, PO BOX 747, FALLS CHURCH, VA, 22040-0747, US

(73) Assignee: SUN NET TECHNOLOGIES CO., LTD

(21) Appl. No.: 11/052,233

(22) Filed: Feb. 8, 2005

(51) Int. Cl. H04J 3/06; H04J 3/04

(52) U.S. Cl. 370/503; 370/535

(57) ABSTRACT

This invention is related to a method and a system for producing and transmitting the multi-media. Some main characteristics are the step of integrating both the image and the sound, which corresponds to numerous received signals, into a multi-media file (the step of simultaneously producing) and the step of sending both the image and the sounds by transmitting the multi-media file (the step of simultaneously transmitting).

### BACKGROUND OF THE INVENTION

1. Field of the Invention

The present invention generally relates to a method and a system for producing and transmitting multi-media. More particularly, relates to a method and a system of synchronous recording and transmission.

2. Description of the Prior Art

Along with the rapid development of the Internet, more and more work can be processed by way of a network. A variety of services are rising and flourishing. Hence the idea of teaching via a network is promoted by taking advantage of the characteristics of the Internet without the hindrance of distance and border. No matter where the teachers and the students are and how far the distances of separation, the students are able to learn the material taught without physically facing the teachers.

For instance, in some prior art, a homepage activity recording apparatus is applied and a synchronous time relationship recording program is used to record the interactive time sequence between the homepage activities and the voice and images of the teachers. Reconstruct or simulate time the sequence by using a homepage activity records playing apparatus, according to a homepage activity synchronous time relationship controlling program; the students can study and watch all the homepage activities with the voice and the image of the teachers by executing each procedure.

However, the prior art could achieve an excepted objective of network teaching, but there are a lot of disadvantages in the practiced application. For example:

(1) Each event is recorded separately. Later the homepage activity synchronous time relationship recording procedure records their synchronous time relationship. Thus, to transmit the information on a network, a complicated mechanism is needed for synchronous playing since the information needs to be partitioned into several pieces for being sent. Furthermore, the delay and discordant phenomenon between the homepage activities, images and voice occurs while transmitting on a network.

(2) Each event is recorded individually. When one or more of events (such as a network address, the contents of a homepage and a file path) change, it results in failure in playing due to the misconnection of the events.

(3) It is necessary for the teachers and students to install the specific software (even hardware) for making and playing multi-media teaching materials, which is inconvenient and difficult to both teachers and students.

Accordingly, in order to teach and learn more effectively on network by way of multi-media, and in order to transmit multi-media files more efficiently, it is necessary to develop a new system to produce and to transmit multi-media teaching materials. Particularly, it is necessary to develop the method and the system for producing and transmitting multi-media.

### SUMMARY OF THE INVENTION

It is one objective of the present invention to provide a method and system for producing and transmitting multi-media teaching materials. It simultaneously retrieves and stores the images on the video device (for instance, a monitor) and the audible sounds from the speaker, which include the images, voice, teacher's operation actions and teaching materials . . . and so on. The retrieved and stored teaching images and sounds are connected to be a whole multi-media file, which can be read and watched easily by the people on the receiving end.

It is another objective of the present invention to apply known technology to improve the prior network teaching techniques (as well as the techniques for transmitting images and sounds on network), which enable to decrease extra technique difficulty and to increase industrial practicability.

The present invention comprises the following main characteristics:

(1) Use of a method and a system for synchronous recording to proceed in the recording and transmitting of multi-media.

(2) Use of a method and a system for synchronous transmitting to proceed in the recording and transmitting of multi-media.

(3) Use known multi-media file format (such as AVI file format) to store multi-media files.

(4) By way of transmitting multi-media files, images and sounds can be transmitted on a network.

Besides, the practical application of the present invention comprises the following characteristics:

(1) When sound and image information are not synchronized, the playing speed in its entirety is usually based on the playing speed of the sound information.

(2) When a period of sound information is not complete, the dummy signal usually makes up for the missing signal.

(3) When there is more than one source of the information, the different images from the different sources will be overlapped.

(4) When the information is updated at a determined period interval, the determined period interval and the updating period interval of the corresponding multi-media files are changeable. And each of them can be unequal.

(5) Multi-media files not only comprise image and sound contents, but also comprise the information that indicate the length and time of a section within a multi-media file is playing.

### BRIEF DESCRIPTION OF THE DRAWINGS

FIG. 1A to FIG. 1C are individual drawings of three drawbacks in the prior art;

FIG. 2 is a diagram with the solution to the difficult point in the present invention;

FIG. 3A to FIG. 3D are diagrams illustrating examples of the preferred embodiment;

FIG. 4 is a flow diagram illustrating another preferred embodiment of the present invention; and

FIG. 5 is a diagram illustrating still another preferred embodiment of the present invention.

### DESCRIPTION OF THE PREFERRED EMBODIMENT

The common drawbacks of the prior art that the inventor of the present invention pointed out in advance, has the following results:

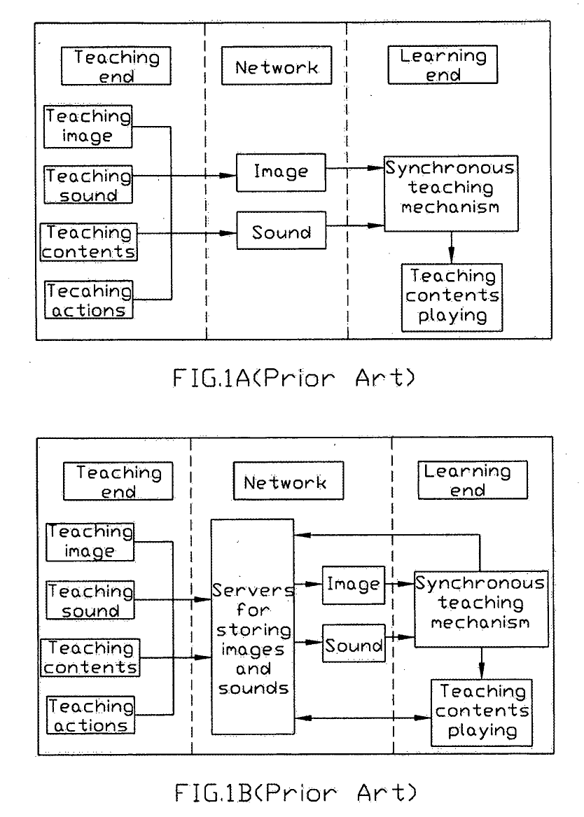

(1) As shown in FIG. 1A, the correlative contents of sound and image are usually transmitted separately during the transmission. Thus, the non-synchronization of images and sounds often arises because the transmission is not synchronized or the information is lost.

(2) As shown in FIG. 1B, what is to be transmitted is often the information of the file addresses, playing sequence and so forth excepted the files of the images or the sounds themselves in the process of network transmission. Accordingly it would not operate correctly because the transmitted files can not react to the change of the file addresses in time.

(3) As shown in FIG. 1C, information (such as sounds, images and the like) coming from different sources are often handled separately. As a consequence, if different information store in separate files, files can not be handled as a whole file at once and the interactive synchronized relationship of the information from different sources can not be effectively ensured.

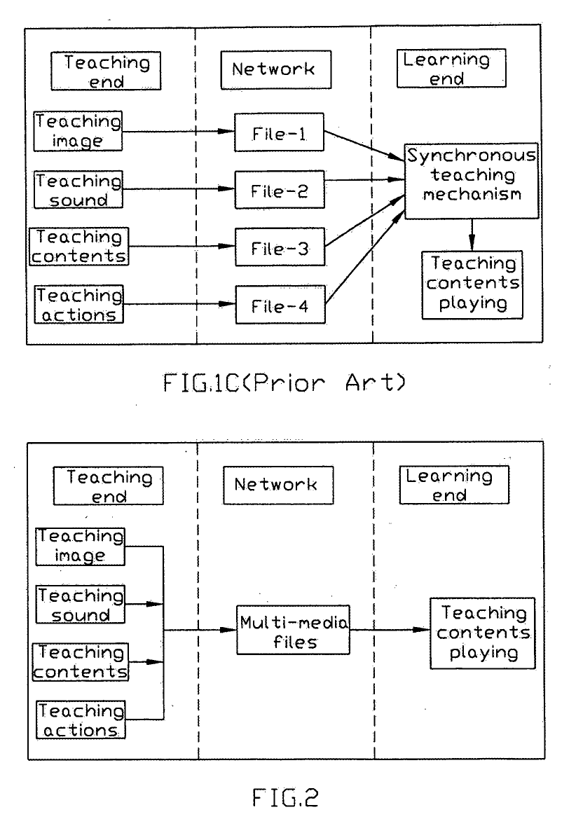

The inventor proceeds to point out the major reasons of the often seen drawbacks, referring to FIG. 2, it could be improved in the following ways:

(1) During the transmission on a network, the correlative contents of voice and images are merged into a single multi-media file for fear of information missing or non-synchronized transmission.

(2) During the transmission on a network, the images and sounds files are transmitted by way of multi-media files. The updating and controlling of the contents for transmitting are integrated in the file producing process, and hence network transmission process is only a pure transmission. Then the user can directly open and read the contents of the files when receiving them, without downloading and inputting correlated setting by hand.

(3) When the receiving information comes from different sources (such as sounds, images, a mouse and the like), the information (such as sounds, images and so on) from different sources are integrated into a multi-media file. For the reason, it can not only handle one file at a time but it also more effectively guarantees the interactive synchronous relationship of different information by storing different information in the same file.

According to the above discussion, one embodiment of the present invention is a system for producing and transmitting multi-media teaching materials. It comprises an emitting terminal and a receiving end. The emitting terminal is used to capture the images on a video device and the sounds from the speaker and to merge them into a general multi-media file. The general multi-media file is mainly used to record several homepage teaching materials, operating environments, teacher's operation actions and sounds from a CCD (Charged Couple Device) or a microphone, and those are merged into a signal file for transmission to avoid any delay or discordant situation. The receiving end is used to receive the file from the emitting terminal. Besides, the file from the emitting terminal is a general multi-media file, which can be viewed directly during transmission or after the whole file is received.

The images to be viewed on a video device and the sounds to be heard on a speaker are gathered and merged into a general multi-media file at the emitting terminal; therefore there is only one file needed for transmission. No more delays or discordant situations occur when the files are read or watched at the receiving end.

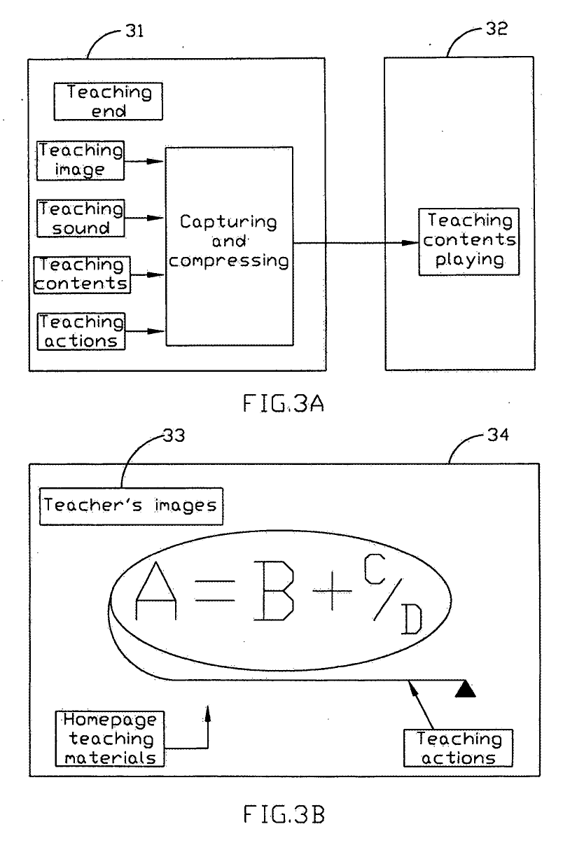

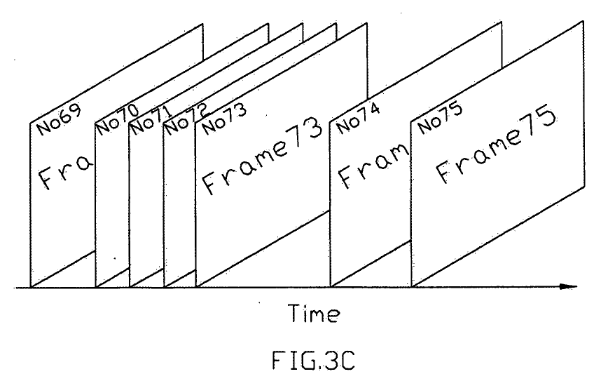

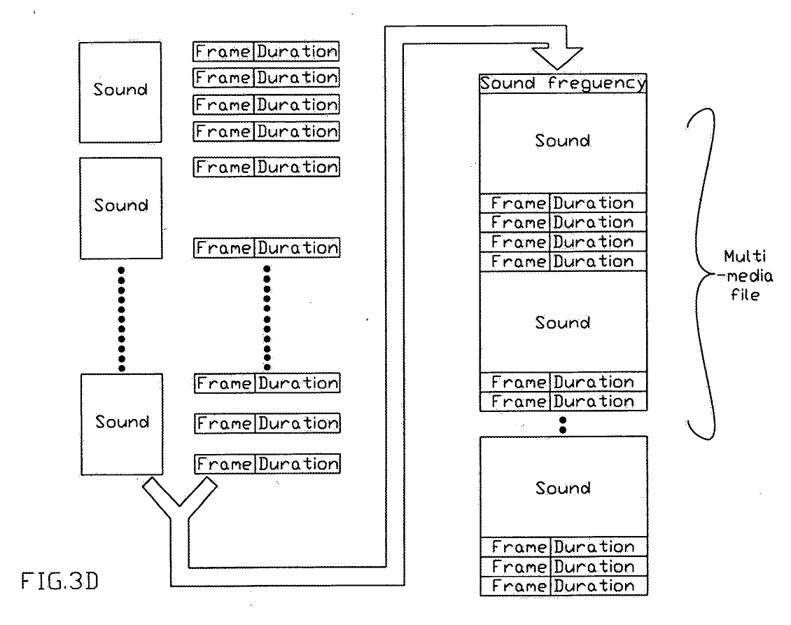

As shown in FIG. 3A, the system for producing and transmitting of the embodiment could be divided into the emitting terminal 31 and the receiving end 32.

The teaching materials homepage, the teacher's operating environment, the teacher's operation actions, the images on the video device and the sounds from the speaker can be captured simultaneously in the emitting terminal 31, which can be equipped with a CCD, digital camera and a microphone. What the operation actions of a teacher or a user display are chosen from a group consisting of the following: lines, signs, pictures and the like made by the teacher and showed on a video device in the operating environment of the emitting terminal. Therefore the size and the position of the teacher's image can be adjusted by the teacher at the emitting terminal 31 for avoiding affecting the teaching picture 34 (As shown in FIG. 3B).

Referring to FIG. 3C, the layout of images shown on the video device is captured as a series of frames during a series of periods. Thus the frames captured in one of the periods can be considered to be an image segment. A frame is a snapshot shown on the video device. Each frame may cost different time to be captured; thereby the interval between successive two frames may be different also. It may be resulted from the performance limitation of the environment. Thus the number of frames of each image segment could be different.

According to the time for generating an image segment and the number of frames, the average playing duration of each frame can be evaluated. The average playing duration of each frame in the image segment is used to be the duration information for identifying how long each frame is displayed at the receiving end. For example, the playing duration coupled with a frame in an image segment is (the time for capturing the image segment)/(the number of the frames in the image segment). By coupling each frame with the duration information in the image segment, each frame has its own duration for playing. Thus even the performance limitation causes the number of frames changed per period, the total playing time of images and the time for capturing all image segments can be matched.

Moreover, sounds heard from a speaker can be captured to be a sound segment per period. According to the sound frequency and the size of all sound segments, the total playing time of sounds can be evaluated. Causing by performance delay or capturing fault, the size of all sound segments may be larger or smaller than it should be. By adjusting the sound frequency according to the size of all sound segments and the total time for capturing all sound segments, the total playing time can be recovered. That is, the sound frequency can be adjusted to match the total playing time of images according to the size of all sound segments and. For instance, if the sounds are captured according to a capturing frequency, then the sound frequency is (capturing frequency)×(the time for capturing all image segment)/(the playing time of all sound segments).

A frame can be captured from the signals for displaying on a video device; it can also be a composite image of a static image and some dynamic images. For example, a composite image can be a static image (i.e. home page teaching materials of 34) coupled with the dynamic image from a CCD (i.e. teacher's image 33), the forgoing operation actions of a teacher (i.e. teaching actions of 34) or both. The static image can be the background image formed by the images from a group consisting of the following: the teaching materials homepage, the teacher's operating environment, the teacher's operation actions and the images on the video device. The dynamic images are generated by the inputs of some multi-media apparatuses (such as CCD, mouse or the like) for generating the foreground images on the static image. That is, the frame can be formed by the static image and the dynamic images directly rather than capturing the signals for displaying on a video device if a frame shown on a video device is a static image coupled one or more dynamic images.

Referring to FIG. 3D, sound segments and image segments are captured during several periods. The image segments contain a series of pairs of frame that each one is coupled with the corresponding duration information. All of the sound segments and the frames with the corresponding duration information are integrated into a multi-media file. Besides, the multi-media file also contained the sound frequency evaluated according to the total size of all sound segments and the total playing time of all frames. Then each frame can be displayed at a duration identified by the duration information and the total playing time of all frames match the total playing time of all sound segments.

Furthermore, the time for capturing each of sound segments or image segments can be different. That is, the images and the sounds can be captured separately. Moreover, even the time for capturing each image segment or sound segment can be different. The time for capturing each image segment or each sound segment is not limited in the present invention.

The multi-media file in the emitting terminal 31 are transmitted on a network to the receiving end 32, so the users can directly watch and read the teaching materials. The general multi-media file, produced in the emitting terminal 31, can also be stored or downloaded to all sorts of storage apparatus. Then off-line transmitting, reading and studying by Windows software such as Media Player and the like are available.

According to the composition and the practiced interpretation of the preferred embodiments described above, the preferred embodiments truly have the following advantages when compared to the prior art:

(1) The embodiment simultaneously captures the images on the video device (for example, the teaching materials, the operating environment of the teaching process and the teacher's operation actions (for example, drawing or circumscribing) of the teachers) and the sounds from the speaker (for example, the voice of the verbal statement of the teachers), then all the pictures are merged to produce a multi-media file. Con-successively there is only one file format in transmission on network, the file can be transmitted by a way faster and it costs less network resources.

(2) The embodiment applies the method to produce the pictures and sounds into a single multi-media file. Then the situation of the delayed pictures and the discordant of the teaching contents never occur when the users in the receiving end read and watch the file, such that the user can study more easily and freely.

(3) The embodiment simultaneously captures the pictures and sounds to produce a common multi-media file without recording the location and sequence relationships of its contents, it is always able to simulate and produce the contents of the teacher's operation actions because of the change in location, contents and files.

(4) The files produced in this embodiment can be web-based files of the multi-media teaching materials. They can be viewed by way of a general browser or an operating system built-in Media Player and the like, without downloading and installing programs at the receiving end. It is capable of increasing the convenience without extra player programs.

Apparently the embodiment is a system for producing and transmitting multi-media. But it can be found that the key of the embodiment is to integrate the images and sounds into a multi-media file and then to transmit them according to the contents of the above discussion. It is not a con-successively relationship between the integrated contents of images and sounds and whether it is teaching materials or not. Namely, the scope of the claim interpretation is not limited to the multi-media teaching materials.

Accordingly, referring to FIG. 5, the system for producing and transmitting of the present embodiment comprises a receiving means, an integrating means, a storing means, a transmitting means, and a plurality of multi-media apparatuses 55. The multi-media apparatuses 55 are the sources to generate forgoing images and sounds. The images and sounds are received by the receiving means 51 for generating signals for displaying the images and playing the sounds. Moreover, the integrating means has the following functions:

capturing said images for forming a plurality of successive image segments, wherein each of said image segments contains a plurality of frames; coupling each of said frames with a duration information, wherein said duration information identifies a playing duration of said frame that said duration information coupled with;

capturing said sounds for forming a plurality of successive sound segments with a capturing frequency, wherein said capturing frequency and the size of said sound segments identify the playing duration of all sound segments;

evaluating a sound frequency according said capturing frequency; and

integrating said plurality of successive image segments, said plurality of successive sound segments and said sound frequency into a multi-media file.

The multi-media file is stored in the storing means 53 and transmitted by the transmitting means 54.

Generally speaking, the software for producing the image contents of the multi-media files from the image segments of the multi-media signals can be displayed from the group consisting of the following: the GDI library of operating systems, image pixels copying functions and the DirectShow functions of the operating systems. And the software for producing the sound contents of the multi-media files from the sound segments of the multi-media signals comprises the DirectSound functions of Windows operating systems.

Additionally, the present embodiment applies methods for transmitting multi-media files, which are displayed from the group consisting of the following: network transmission, network playing, local playing and storing in magnetic and optical mediums. And the present embodiment is displayed from the group consisting of the following: microphones, recording pens, recorders, recording apparatuses, video cameras, monitors, cameras, digital cameras, charge coupled components, photo-graphic apparatuses, touch pad, handwriting input apparatuses, drawing software, image software, sound effect software and computer software.

Apparently, the present embodiment uses all kinds of methods to deal with image and sound information in each period to integrate the demand multi-media files. It should be noted that all applied methods are not limited to the determined hardware or software for execution, and this puts boundaries on the necessary reaching function. In other words, the present embodiment does not restrict the details of the corresponding system.

In the meantime, the receiving means 51 can execute the functions displayed from the group consisting of the following: the GDI library of operating systems, image pixels copying functions, the DirectShow functions of operating systems and the DirectSound functions of operating systems. The receiving means 51 can be one of the following hardware: microprocessors, application specific integrated circuits, microchips and the central processing units.

Additionally, the multi-media apparatuses are displayed from the group consisting of the following: microphones, recording pens, recorders, recording apparatuses, video cameras, monitors, cameras, digital cameras, charge coupled components, photographic apparatuses, touch pads, handwriting input apparatuses, drawing software, image software, sound effect software and computer software.

The integrating means 52 is used to integrate the multi-media information into a multi-media file. The multi-media file can be separate into the image contents of the corresponding images and the sound contents of the corresponding sounds. By way of only analyzing the multi-media files, these corresponding images and sound can be acquired and it does not need to refer to any file or apparatus not belonging to the multi-media files.

In the meantime, the integrating means 52 can usually execute at least one of the functions displayed from the group consisting of the following: the GDI library of operating systems, the picture difference handling programs, the VCM library of operating systems, compressing programs, the VFW library of operating systems, imitative sound producing programs, images and sounds synchronizing programs, the DirectShow functions of operating systems and the DirectSound functions of operating systems. The integrating means 52 can be displayed from the group consisting of the following hardware: microprocessors, application specific integrated circuits, microchips and central processing units.

The storage means 53 is used to store these multi-media signals and the multi-media files, and it can store the temporary files produced in the operating process the integrating means 52 Generally speaking, the storage means 53 can be displayed from the group consisting of the following hardware: dynamic random accessing memories, static random accessing memories, flash rams, hard drives, and magnetic and optical storage mediums.

The transmitting means 54 is used to transmit the multi-media files.

Meanwhile, the transmitting means 54 is displayed from the group consisting of the following methods for transmitting multi-media files: network transmission, network playing, local playing and storing in magnetic and optical mediums.

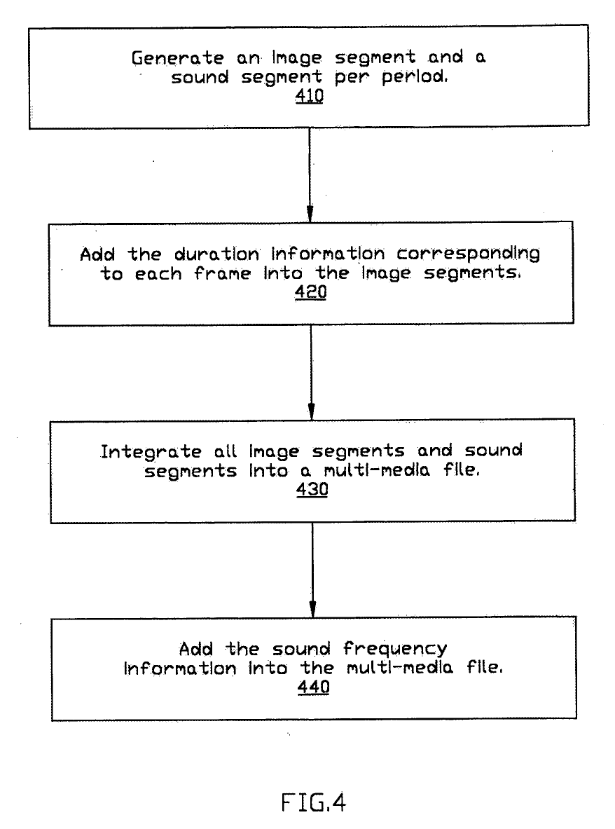

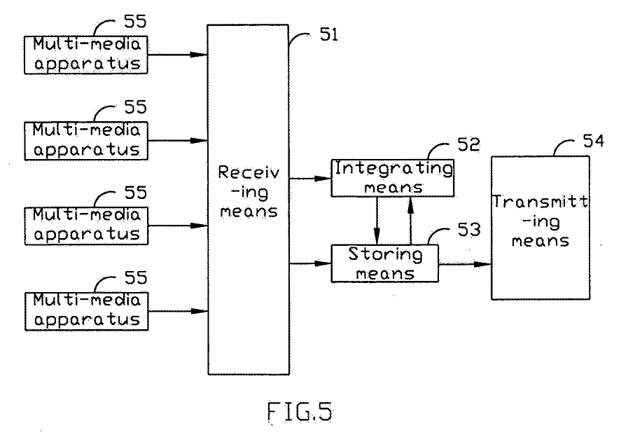

Accordingly, another embodiment of the present invention is a system for producing and transmitting. FIG. 4 is a flow diagram of the present embodiment. Step 410 generates an image segment and a sound segment per period. Then, step 420 adds the duration information corresponding to each frame into the image segments. Furthermore, step 430 integrates all image segments and sound segments into a multi-media file. Finally, step 440 adds the sound frequency information into the multi-media file. The other details of the present embodiment has mentioned above, so no more redundant is described here.

The preferred embodiments are only used to illustrate the present invention; it is not intended to limit the scope thereof. Many modifications of the embodiments can be made without departing from the spirit of the present invention.

What is claimed is:

1. A method for producing and transmitting multimedia, comprising:
capturing images for forming a plurality of successive image segments, wherein each of said image segments contains a plurality of frames;
coupling each of said frames with a duration information, wherein said duration information identifies a playing duration of said frame that said duration information coupled with;
capturing sounds for forming a plurality of successive sound segments with a capturing frequency, wherein said capturing frequency and the size of said sound segments identify the playing duration of all sound segments;
evaluating a sound frequency according said capturing frequency;
integrating said plurality of successive image segments, said plurality of successive sound segments and said sound frequency into a multi-media file;
transmitting said multi-media file.

2. The method of claim 1, wherein the sum of said playing durations been coupled with said frames in said image segment equals the time for capturing said image segment.

3. The method of claim 2, wherein said playing duration coupled with said frame in said image segment is (the time for capturing said image segment)/(the number of said frames in said image segment).

4. The method of claim 1, wherein said sound frequency is (capturing frequency)×(the time for capturing all of said image segment)/(the playing time of all of said sound segments).

5. The method of claim 1, wherein said image segments are captured from the signals for displaying said images.

6. The method of claim 1, wherein said sound segments are captured from the signals for playing said sounds.

7. The method of claim 1, wherein said frame is formed by a static image and at least one dynamic image on said static image.

8. The method of claim 7, wherein said dynamic image is from a charged coupled device (CCD).

9. The method of claim 7, wherein said dynamic image is resulted from the operation actions of a user.

10. The method of claim 1, wherein the contents that said frames display are displayed from a group consisting of the following: the teaching materials homepage, the teacher's operating environment, the teacher's operation actions, and the images.

11. A system for producing and transmitting multimedia, comprising:
a plurality of multi-media apparatuses, said multi-media apparatus are the sources to generate images and sounds;
receiving means for receiving said images and said sounds and generating signals for displaying said images and playing said sounds;
integrating means for the following functions:
capturing said images for forming a plurality of successive image segments, wherein each of said image segments contains a plurality of frames; coupling each of said frames with a duration information, wherein said duration information identifies a playing duration of said frame that said duration information coupled with;
capturing said sounds for forming a plurality of successive sound segments with a capturing frequency, wherein said capturing frequency and the size of said sound segments identify the playing duration of all sound segments;
evaluating a sound frequency according said capturing frequency; and
integrating said plurality of successive image segments, said plurality of successive sound segments and said sound frequency into a multi-media file; and
transmitting means for transmitting said multi-media file.

12. The system of claim 11, wherein the sum of said playing durations been coupled with said frames in said image segment equals the time for capturing said image segment.

13. The system of claim 12, wherein said playing duration coupled with said frame in said image segment is (the time for capturing said image segment)/(the number of said frames in said image segment).

14. The system of claim 11, wherein said sound frequency is (capturing frequency)×(the time for capturing all of said image segment)/(the playing time of all of said sound segments).

15. The system of claim 11, wherein said image segments are captured from the signals for displaying said images.

16. The system of claim 11, wherein said sound segments are captured from the signals for playing said sounds.

17. The system of claim 11, wherein said frame is formed by a static image and at least one dynamic image on said static image.

18. The system of claim 17, wherein said dynamic image is from a charged coupled device (CCD).

19. The system of claim 17, wherein said dynamic image is resulted from the operation actions of a user.

20. The system of claim 1 1, wherein the contents that said frames display are displayed from a group consisting of the following: the teaching materials homepage, the teacher's operating environment, the teacher's operation actions, and the images.

21. The system of claim 1 1, further comprising storing means for storing said multi-media file.
